(19) United States
(12) Patent Application Publication
(10) Pub. No.: US 2017/0246686 A1
(43) Pub. Date: Aug. 31, 2017

(54) PASTES FOR PRINTING THREE-DIMENSIONAL OBJECTS IN ADDITIVE MANUFACTURING PROCESSES

(71) Applicant: Hewlett-Packard Development Company, L.P., Houston, TX (US)

(72) Inventors: Susanne Klein, Stroud (GB); Fraser Dickin, Bristol (GB); Guy Adams, Stroud (GB); Steven J. Simske, Fort Collins, CO (US)

(21) Appl. No.: 15/511,004

(22) PCT Filed: Sep. 26, 2014
(86) PCT No.: PCT/US2014/057636

§ 371 Date: Mar. 13, 2017

(51) Int. Cl. B22F 3/12; B22F 3/00; C03C 8/02; C03C 14/00; C08J 5/12; C03C 3/087; B29C 67/00; B22F 3/22

(52) U.S. Cl. CPC B22F 3/1208; B29C 67/0055; B22F 3/008; B22F 3/22; C03C 14/008; C08J 5/127; C03C 3/087; C03C 8/02; C03C 2214/30

(57) ABSTRACT

A composition for the additive manufacture of three-dimensional objects is provided. The composition includes a sinterable frit, a protein binder, and an aqueous-based solvent.

### BACKGROUND

Additive manufacturing (AM), also known as 3D printing, may be used to make a three-dimensional object of almost any shape from a 3D model or other electronic data source primarily through additive processes in which successive layers of material are laid down under computer control.

3D-printing, along with other additive manufacturing and rapid prototyping (RP) techniques, involves building up structures in a layer by layer fashion based upon a computer design file. Such techniques are well suited to the production of one-off, complex structures that would often be difficult to produce using traditional manufacturing methods. There has been rapid growth and interest in this field during recent years and a range of techniques are now available which make use of many common materials such as plastic, metal, wood and ceramic. However, relatively little has been done to develop AM using glass.

### BRIEF DESCRIPTION OF THE DRAWINGS

FIG. 1 is a process chart, depicting a method of manufacturing a three-dimensional object, according to an example

FIG. 2, on coordinates of Young's modulus (in GPa) as a function of different frit sizes, according to an example.

### DETAILED DESCRIPTION

It is appreciated that, in the following description, numerous specific details are set forth to provide a thorough understanding of the examples. However, it is appreciated that the examples may be practiced without limitation to these specific details. In other instances, well-known methods and structures may not be described in detail to avoid unnecessarily obscuring the description of the examples. Also, the examples may be used in combination with each other.

While a limited number of examples have been disclosed, it should be understood that there are numerous modifications and variations therefrom. Similar or equal elements in the Figures may be indicated using the same numeral.

It is be noted that, as used in this specification and the appended claims, the singular forms “a,” “an,” and “the” include plural referents unless the context clearly dictates otherwise.

As used herein, the term “about” is used to provide flexibility to a numerical range endpoint by providing that a given value may be “a little above” or “a little below” the endpoint, and may be related to manufacturing tolerances. The degree of flexibility of this term can be dictated by the particular variable and would be within the knowledge of those skilled in the art to determine based on experience and the associated description herein. In some examples, “about” may refer to a difference of ±10%.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or subranges encompassed within that range as if each numerical value and subrange is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual values such as 2, 3.5, and 4 and sub-ranges such as from 1 to 3, from 2 to 4, and from 3 to 5, etc. This same principle applies to ranges reciting only one numerical value. Furthermore, such an interpretation should apply regardless of the breadth of the range or the characteristics being described.

Powder printing with glass has been demonstrated. However, the process may have some disadvantages: (1) the binder and the amount of binder used may discolor the fired object; (2) due to the powder bed process, the final object may be porous; and (3) the object may be fired in a powder as support material, which may leave the object surface matte, that is, the object may not be perceived as made out of glass.

A modified powder bed printer has been used to generate ceramic greenware; the recipes have been optimized to reduce shrinkage of the greenware. The greenware is then fired following traditional methods of the ceramic industry. Again, the powder bed process results in a rather porous final object which needs to be glazed to become suitable for use with fluids.

Traditional assembly line manufacturing is speculative, costly and environmentally unsustainable. It is speculative because it commits substantial resources—energy, materials, shipping, handling, stocking and displaying—without a guaranteed sale. It is costly because each of these resources—material, process, people and place—involves expenses not encountered when a product is manufactured at the time of sale. It is environmentally unsustainable because, no matter how much recycling is done, not using the resources unless actually needed is always a better path.

Glass is a silica-based material. With 90% of the earth's crust composed of silicate minerals, there will be no shortage of silica resources. Glass is easy to recycle and is environmentally friendly. Glass is inexpensive but looks precious, is pleasant to the touch and is so familiar that customers will not be disappointed by its fragility—under certain conditions.

Warm glass or kiln glass is the oldest glass manufacturing method. Glass powder, or frit, is shaped in a mold and fired at moderate temperatures. The powder fuses and a solid glass object is the result. Depending on firing temperature and duration, the glass grains just stick and keep their sandy appearance or melt together and form a smooth body. The major difference between kiln glass and blown glass is that the molten glass mass is not agitated in the kiln glass process. Therefore, kiln glass may contain many more air bubbles than blown glass. 3D printing cannot replace the firing process, but can make the mold obsolete. 3D printing essentially serves three functions:
1) Shaping of the object: to give a semi-finished product (“greenware”) the desired geometry.
2) Compaction of the powder: To give the greenware mechanical strength so it can be handled in further stages of the production process.
3) Densification of the powder: To minimize gaps between the powder particles to give the fired object the desired mechanical, electrical, and optical properties.

For all three functions, a solvent, such as water, and a binder in addition to the glass powder may be employed. In ceramic production, clay is not only part of the so-called body but has the function of a binder as well. In glass products, clay may not be present. Published recipes disclose 40 wt % of polysaccharides may be added to the glass water mixture. Polysaccharides caramelize at temperatures between 110° and 180° C. Above 250° C., caramel decomposes into carbon monoxide and carbon dioxide, hydrocarbons, alcohols, aldehydes, ketones and several furan derivatives, which are volatile. If the caramel is trapped inside the sample, this decomposition may be incomplete and may lead to a discoloration of the sample. The polysaccharide content may need to be reduced drastically to avoid this effect.

The following groups of binders have been tested: polysaccharide-based binders, clay-based binders, and gelatin-based binders. The gelatin binders do not char during firing; see Table I below.

TABLE I

| | Minimum Percentage | |
|---|---|---|
| Gelling Agent | of Glass Powder | Charring |
| Dextrin | 40 wt % | some on inside |
| Dextrin/Fructose | 25/25 wt % | perhaps some on |
| | | inside |
| LAPONITE B* | 3 wt % | no |
| LAPONITE XLG* | 40 wt % | none, but opaque |
| LAPONITE JS* | 40 wt % | yes |
| Gelatin from bovine skin | 4.6 wt % | no |
| Gelatin from porcine skin | 8.9 wt % | no |

*LAPONITE is a clay, specifically, a colloidal layered silicate, available from BYK-Gardner GmbH.

In accordance with the teachings herein, a composition for the manufacture of three-dimensional objects is provided. The composition may include a sinterable frit, a protein binder, and an aqueous-based solvent.

The frit content may vary between about 4 to 60 wt %. By “sinterable frit” is meant a powder that can be sintered and may have a particle size range between 100 nm and 150 μm. As used herein, the term “sintering” means to cause a powder to form a coherent mass by heating without melting it to the point of liquefaction. The sinterable frit may be a glass or a ceramic or a metal. Any of the glass compositions, in powder form, including, but not limited to, soda-lime-silica glasses, sodium borosilicate glasses, fused silica, and alumino-silicate glasses may be employed. Any of the powdered ceramic compositions, such as metal oxides, may be used. Non-limiting examples of metal oxides include titania, silica, zirconia, and alumina. Any of the powdered metals, such as gold, platinum, copper, silver, zinc, and aluminum, and alloys such as brass, steel, and bronze, may be used.

The binder content may vary between about 0.5 to 10 wt %. The binder may be a protein. As used herein, proteins are large biological molecules, or macromolecules, consisting of one or more long chains of amino acid monomers. Examples of suitable proteins employed in the practice of the teachings disclosed herein include, but are not limited to, gelatin and casein.

The solvent content may vary between about 30 to 95.5 wt %. The solvent may be, for example, water or alcohol. The alcohol may be an alkyl alcohol, such as a lower chain alcohol having from 1 to 3 carbon atoms, for example, methanol, ethanol, and isopropyl alcohol. The alcohol may alternatively be an aromatic alcohol, such as benzyl alcohol.

In some examples, the sinterable frit that is combined to form the mixture, or paste with the protein binder, and the aqueous-based solvent may be one that can be sintered at temperatures above 400° C. At lower sintering temperatures, the binder may not burn off completely. In some examples, such a sinterable frit that can be sintered at temperatures above 400° C. may be soda-lime-silica glass.

Depending on the viscosity of the paste, it can be dispensed via an extrusion process or by a jetting process. In some examples, the pastes may behave like a Bingham plastic, showing shear thinning. Specifically, a Bingham plastic is a viscoplastic material that behaves as a rigid body at low stresses but flows as a viscous fluid at high stress. Pastes made from a combination of frit, binder, and solvent may show shear thinning from 10⁵ Pascal seconds (Pa·s) down to 50 Pa·s under shear. For jetting, suspensions with viscosities between 20 mPa·s and 8 Pa·s may be useful. To achieve these low viscosities, dispersants and/or stabilizers may be added as well.

Examples of dispersants suitably employed in the practice of the teachings disclosed herein may include, but are not limited to, Tego® Dispers 755W (an aqueous preparation of modified polymers with pigment affinitive groups), Tego® Dispers 715W (polyacrylic acid sodium salt in water), Tego® Dispers 750W (an aqueous solution of a copolymer with groups of high pigment affinity) (the Tego® Dispers dispersants are available from Evonik Industries, Germany), Disperbyk® 111 (copolymer with acidic groups), Disperbyk® 190 (solution of a high molecular weight block copolymer with pigment affinic groups), and Disperbyk® 192 (copolymer with pigment affinic groups) (the Disperbyk® dispersants are available from BYK USA Inc., CT). The amount of the dispersant may be present in an amount with a range of 5 to 40 wt % of the frit composition.

The mixture of frit, binder, and solvent may allow the paste to be deposited at room temperature in order to generate 3D objects. After the evaporation of the solvent, the object is robust enough to be handled, but is further hardened by a firing process. During firing, the binder burns off and a glass/ceramic object results.

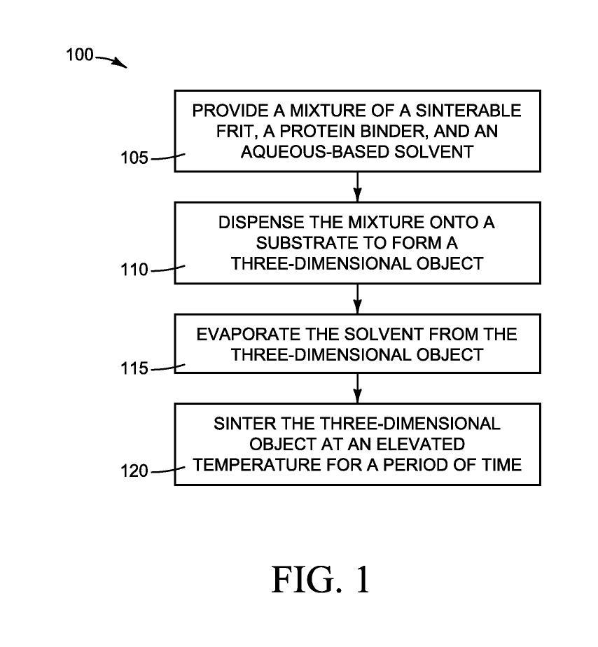

A method 100 of manufacturing a three-dimensional object is depicted in FIG. 1. The method 100 includes providing 105 a mixture of a sinterable frit, a protein binder, and an aqueous-based solvent. The sinterable frit, protein binder, and aqueous-based solvent are as described above.

The method 100 continues with dispensing 110 the mixture onto a substrate to form the three-dimensional object. Dispensing 110 may be done by jetting or by extrusion, depending on the viscosity of the mixture, as described above.

The method 100 further continues with evaporating 115 the solvent from the three-dimensional object. Evaporating 115 may be performed within a temperature range from about 20° to 80° C. for a period of time ranging from about 5 min to 12 hours, depending on the size of the printed object.

The method 100 concludes with sintering 120 the three-dimensional object at an elevated temperature for a period of time. In particular, the sintering temperature may be greater than 400° C. Firing 120 is very material-dependent, but can be determined without undue experimentation. An example of a firing schedule for soda-lime-silica glass may be: ramp at 280° C./hr to 150° C., hold at 150° C. for 10 min, ramp at 450° C./hr to 800° C., hold at 800° C. for 15 min, ramp at 9999° C./hr to 510° C., hold at 510° C. for 60 min, ramp at 100° C./hr to 420° C., hold at 420° C. for 10 min, ramp at 100° C./hr to 40° C., and cool to room temperature to terminate the process. An example of a firing schedule for a metal may be: ramp at 300° C./hr to its melting temperature plus 60° C., hold at that temperature for 30 min, and cool to room temperature to terminate the process.

### EXAMPLES

The following issues may be present with using proteins such as gelatin: Storage at room temperature (4 weeks) can lead to mold formation and separation of glass and water. Gelatin poses an additional issue (which could be used as an advantage): its gel strength is very temperature-dependent. The printhead may need to be kept at a constant temperature to allow successful extrusion.

As a printing process, extrusion was chosen, since densification can pose a problem in powder bed printing, another 3D printing technology. During the extrusion process, a column of body passes through a shaped opening or nozzle. From there the shaped material or bead of constant cross section flows freely. The shape of the object may be generated by directing the flow either by moving the printhead and/or the support stage. During the extrusion process, the binder has two functions: (1) to prevent discontinuous shear thickening and (2) to keep the printed shape intact before the object is fired.

### Discontinuous Shear Thickening

A viscosity is a measure of energy dissipation rate under shear in a fluid. It may be defined as the ratio of shear stress to shear rate during steady flow. For Newtonian liquids, the viscosity is a material parameter and independent of the shear rate, but suspensions of particles in such a fluid can display non-Newtonian behavior. The viscosity can vary with shear rate. For 3D printing of glass, it is desirable that the suspensions behave like Bingham plastics, i.e. materials that behave like a rigid body under low shear rate but flow as viscous fluids under high shear rate. Glass suspended in water would not behave like that at all if the glass particles are smaller than 1 mm in diameter. It exhibits a dramatic increase in viscosity under pressure. The mixture jams. This phenomenon has been extensively studied. A suspension of glass in water cannot be extruded through nozzle sizes necessary for 3D printing. Addition of a binder prevents the glass particles from touching under pressure and keeps the water in the gaps. But discontinuous shear thickening can still occur, which is a dramatic but reversible increase in viscosity under shear. Shear thickening is a cause of concern in many industrial processes since it can damage machinery. Proteins such as gelatin provide shear thinning but no shear thickening under the experimental conditions described below.

### Shape of the So-Called Greenware

To test the pastes and to 3D print some objects, a modified Borg printer was used. The head was replaced by a syringe whose piston was driven by a stepper motor. The tips had a diameter between 0.3 and 0.8 mm, depending on the desired resolution. Since it is a single head and feed system, support material could not be printed.

The viscosity of the paste and the pressure of the print head onto the layer underneath are tuned in such a way that adhesion between the layers is optimal but the shape is not deformed. After the structure is printed, it is dried. In the wet state, the binder prevents the particles from touching, while in the dry state, the binder prevents the particles from falling apart, i.e. it holds the structure together. The greenware has to be robust enough to be handled because for the firing process not only a transfer into a high temperature oven is necessary but also the object has to be embedded into support material to counteract deformations during the firing process.

### Example 1

50 wt % of glass powder frit (Bullseye soda-lime-silica glass), with particle sizes smaller than 80 μm, was mixed with 2.5 wt % of porcine gelatin and 47.5 wt % of water. The paste was filled into a dispensing syringe and printed on a flat glass blank using the modified 3D printer described above. The object was then fired at 720° C. for 5 min. If desired, the object could be shaped by a second firing process via slumping.

### Example 2

63 wt % of glass powder frit (Bullseye soda-lime-silica glass), with particles sizes smaller than 90 μm, was mixed with 1.5 wt % of porcine gelatin and 35.5 wt % water. The paste was filled into a dispensing syringe and printed on a film, building up a three dimensional object using the modified 3D printer described above. The object could be embedded into plaster or vermiculite as support material during firing. Fusion of the glass particles was again achieved by firing at 720° C. for 5 to 10 min, depending on the size of the object. The support material preserved the shape of the greenware; therefore, a second firing process may not be necessary.

### Comments on Particle and Nozzle Size:

As mentioned before, the maximum particle size for shear thickening is about 1 mm. It has been found that the greenware becomes brittle and cannot be handled safely anymore when the particle size is larger than about 250 μm. Discontinuous shear thickening is not an intrinsic bulk material response but highly dependent on boundary conditions. It has been found that for nozzle diameters less than 3 times the maximal particle diameter, blockage will occur frequently, which is partly reversible and partly irreversible.

### Material Properties After Firing

To determine the mechanical properties of the printed glass after firing, a series of test samples with different frit sizes was produced and compared with solid glass samples cut from so-called glass billets, commercially available glass blocks sold for casting (Bullseye soda-lime-silica glass). All samples had to be cut and polished in order to have the same volume and even and parallel surfaces. The density of the material was determined as a function of weight and volume; see Table II below. The density of the powder-based samples (frits) was about 8% lower than that of the billet glass. An SEM of the powder-based samples showed that the fired samples had air inclusions.

TABLE II

| Sample, Bulk | Density kg/m³ | Sample, Frit* | Density kg/m³ |
|---|---|---|---|
| Billet 1 | 2470 | φ < 38 | 2303 |
| Billet 2 | 2457 | 38 < φ < 63 | 2319 |
| Billet 3 | 2324 | 63 < φ < 75 | 2340 |
| Billet 4 | 2483 | 75 < φ < 150 | 2272 |
| Billet 5 | 2457 | 150 < φ < 250 | 2458 |
| average | 2438 | average | 2309 |
| Std. Dev. | 65 | Std. Dev. | 29 |

*The particle size φ is in μm. Each billet had a different range of particle size.

The elastic modulus or Young's modulus, a quantity which measures how rigid a material is, was measured using pulse-echo ultrasound testing. Ultrasound pulses were sent into the sample and their echoes off the back wall of the sample were recorded. Under the assumption that the samples were isotropic, the Young's modulus was calculated from the speed of sound.

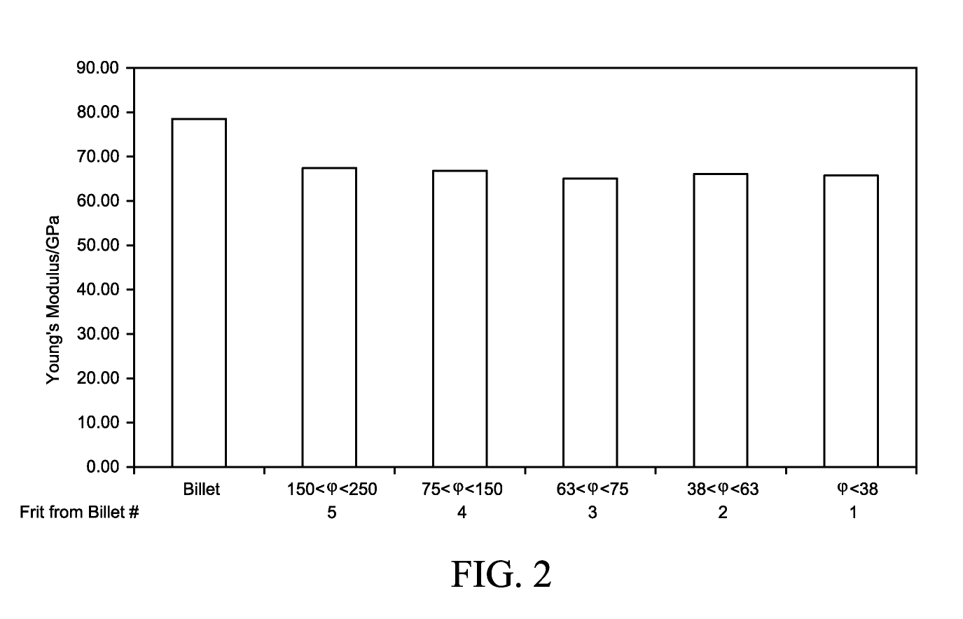

The values of Young's modulus were measured on each of the frits derived from the respective billets listed in Table II, as well as on a billet. The results are depicted in FIG. 2.

FIG. 2 shows that the Young's modulus is near 70 GPa, an average value for soda-lime-silica glass. The frits are seen to produce much the same results, but are lower than the billet. This may be due to the fact that the billets are cast, solid glass, while the frit samples are porous because of air inclusions.

### CONCLUSIONS

The addition of protein binders to a glass water mixture leads to shear thinning of the paste and robustness of the greenware. Fired samples are not optically transparent because of air inclusions but show similar mechanical properties compared to glass made by casting.

What is claimed is:

1. A composition for the additive manufacture of three-dimensional objects, the composition including a sinterable frit, a protein binder, and an aqueous-based solvent.

2. The composition of claim 1, comprising:
about 4 to 60 wt % of the sinterable frit;
about 0.5 to 10 wt % of the protein binder; and
about 30 to 95.5 wt % of the aqueous-based solvent.

3. The composition of claim 1, wherein the sinterable frit is selected from the group consisting of glasses, ceramics, and powdered metals.

4. The composition of claim 3, in which the glasses are selected from the group consisting of soda-lime-silica glasses, sodium borosilicate glasses, fused silica, and aluminosilicate glasses; the ceramics are selected from the group consisting of titania, silica, zirconia, and alumina; and the powdered metals are selected from the group consisting of gold, platinum, copper, silver, zinc, and aluminum, and alloys selected from the group consisting of brass, steel, and bronze.

5. The composition of claim 3, wherein the sinterable frit has a sintering temperature above about 400° C.

6. The composition of claim 1, wherein the protein binder is selected from the group consisting of gelatin and casein.

7. The composition of claim 1, wherein the solvent is selected from the group consisting of water, an alcohol selected from the group consisting of C₁ to C₃ alcohols, benzyl alcohol, and mixtures thereof.

8. The composition of claim 1, further including a dispersant in an amount within a range of about 5 to 40 wt % of the composition.

9. A composition for the additive manufacture of three-dimensional objects, the composition comprising:
about 4 to 60 wt % of a sinterable frit;
about 0.5 to 10 wt % of a protein binder; and
about 30 to 95.5 wt % of an aqueous-based solvent,
wherein the sinterable frit is selected from the group consisting of glasses, ceramics, and powdered metals;
wherein the protein binder is selected from the group consisting of gelatin and casein; and
wherein the solvent is selected from the group consisting of water, an alcohol selected from the group consisting of C₁ to C₃ alcohols, benzyl alcohol, and mixtures thereof.

10. The composition of claim 9, further including a dispersant in an amount within a range of about 5 to 40 wt % of the composition.

11. A method of additively manufacturing a three-dimensional object, the method including:
providing a mixture of a sinterable frit, a protein binder, and an aqueous-based solvent;
dispensing the mixture onto a substrate to form the three-dimensional object;
evaporating the solvent from the three-dimensional object; and
sintering the three-dimensional object at an elevated temperature for a period of time.

12. The method of claim 11, wherein the mixture comprises:
about 4 to 60 wt % the sinterable frit;
about 0.5 to 10 wt % the protein binder; and
about 30 to 95.5 wt % the aqueous-based solvent.

13. The method of claim 11, wherein the mixture is dispersed by an extrusion process or by jetting.

14. The method of claim 11, wherein the aqueous-based solvent is evaporated at a temperature in a range from about 20° to 80° C. for a period of time ranging from about 5 min to 12 hours.

15. The method of claim 11, wherein the three-dimensional object is sintered at a temperature above 400° C. for a period of time.
